(19) United States
(12) Patent Application Publication
(10) Pub. No.: US 2019/0282879 A1
(43) Pub. Date: Sep. 19, 2019

(54) PUNCHING DEVICE

(71) Applicant: Jubei Knight, Tampa, FL (US)

(72) Inventor: Jubei Knight, Tampa, FL (US)

(21) Appl. No.: 16/263,542

(22) Filed: Jan. 31, 2019

Related U.S. Application Data
(60) Provisional application No. 62/642,446, filed on Mar. 13, 2018.

(51) Int. Cl. A63B 69/20; A63B 69/00

(52) U.S. Cl. CPC A63B 69/20; F16M 13/022; A63B 69/004

(57) ABSTRACT

A punching device includes a target pad, a clip, at least one elastic cord, and at least one hook. The target pad includes an outer covering defining an internal compartment, and a filler material disposed within the internal compartment. The target pad has a punching surface and a back surface opposite the punching surface. The clip is coupled to the back surface of the target pad. The elastic cord includes a first end coupled to the back surface. The hook is coupled to a second end of the elastic cord.

### CROSS-REFERENCE TO RELATED APPLICATION

This application claims the benefit of priority of U.S. provisional application No. 62/642,446, filed Mar. 13, 2018, the contents of which are herein incorporated by reference.

### BACKGROUND OF THE INVENTION

The present invention relates to a punching device and, more particularly, to a punching device suspendable within a mixed martial arts cage.

A punching bag is a sturdy bag designed to be repeatedly punched. A punching bag is usually cylindrical and filled with various materials of corresponding hardness. Punching bags may be used to train for fighting, as well as a recreational exercise tool.

Currently, mixed martial arts (MMA) fights are performed in either a ring or fenced area. The fenced area can be round or have at least six sides. The fenced area may sometimes be referred to as a cage. MMA cages currently have no other purpose other than to keep fighters within a boundary during a fight.

As can be seen, there is a need for a punching device that may be setup in a cage for training purposes.

### SUMMARY OF THE INVENTION

In one aspect of the present invention, a punching device comprises: a target pad comprising an outer covering defining an internal compartment, and a filler material disposed within the internal compartment, wherein the target pad comprises a punching surface and a back surface opposite the punching surface; a clip coupled to the back surface of the target pad; at least one elastic cord comprising a first end coupled to the back surface; and at least one hook coupled to a second end of the at least one elastic cord.

In another aspect of the present invention, a method of releasably attaching a punching device to a fencing comprises: providing the punching device comprising: a target pad comprising an outer covering defining an internal compartment, and a filler material disposed within the internal compartment, wherein the target pad comprises a punching surface and a back surface opposite the punching surface; a clip coupled to the back surface of the target pad; at least one elastic cord comprising a first end coupled to the back surface; and at least one hook coupled to a second end of the at least one elastic cord; placing the back surface of the punching device against the fencing; attaching the clip to the fencing; stretching the at least one elastic cord downwards away from the target pad; and attaching the at least one hook to the fencing.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is back perspective view of an embodiment of the present invention;

FIG. 3 is a side view of an embodiment of the present invention; and

FIG. 4 is a perspective view of an embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a travel size punching device that can hook and attach onto all MMA cages and at home fences. Hooking the present invention to a cage enhances ones training ability and utilizes the cage. The present invention provides for the option to train by yourself.

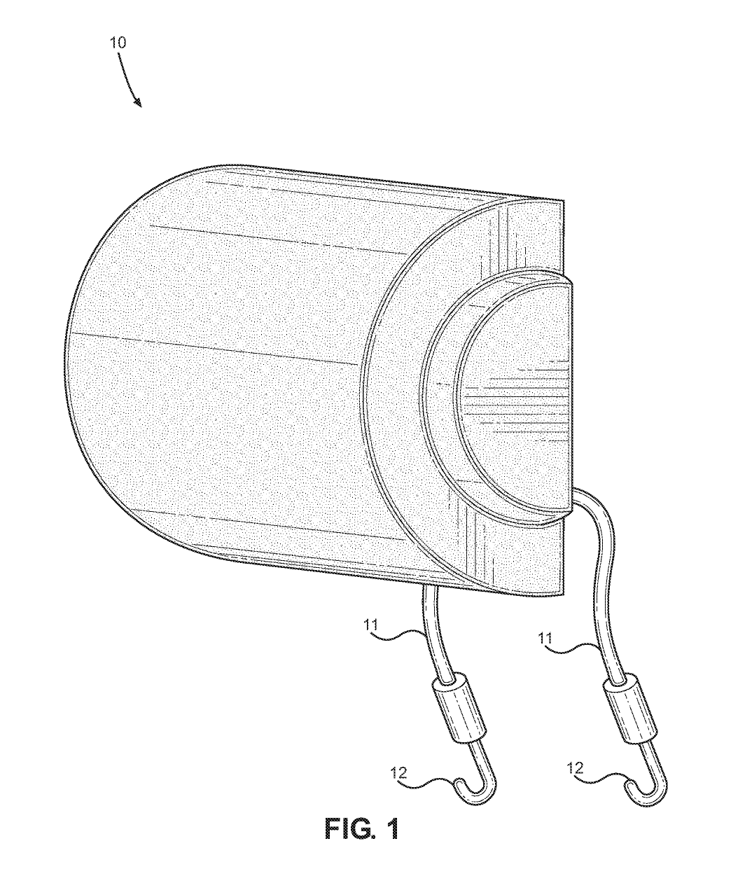

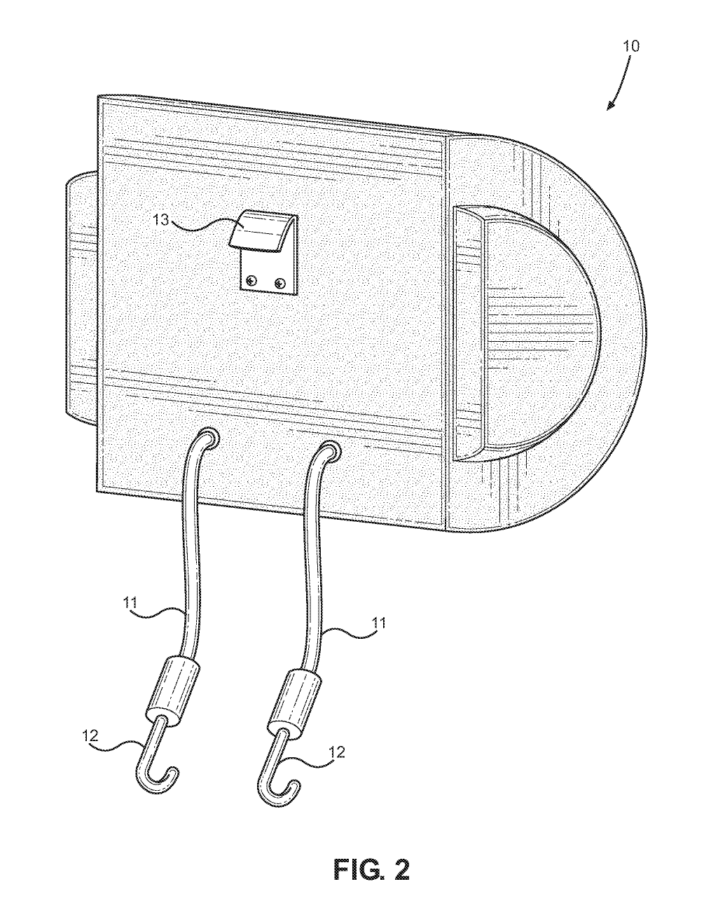

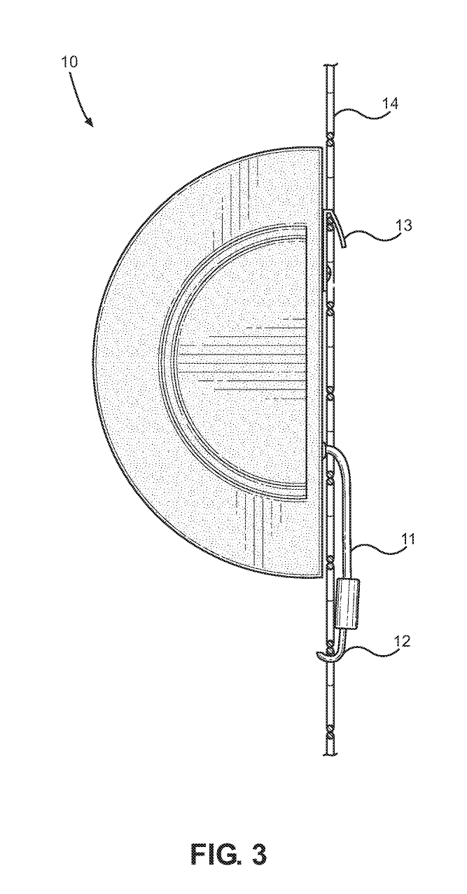

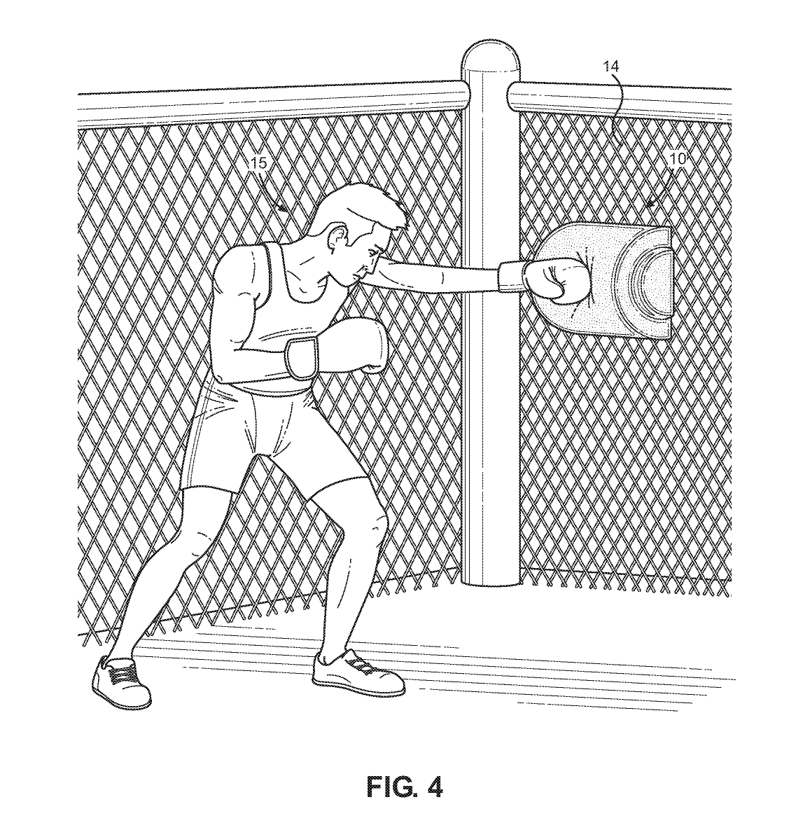

Referring to FIGS. 1 through 4, the present invention includes a punching device. The punching device includes a target pad 10, a clip 13, at least one elastic cord 11, and at least one hook 12. The target pad 10 includes an outer covering defining an internal compartment, and a filler material disposed within the internal compartment. The target pad 10 has a punching surface and a back surface opposite the punching surface. The clip 13 is coupled to the back surface of the target pad 10. The elastic cord 11 includes a first end coupled to the back surface. The hook 12 is coupled to a second end of the elastic cord 11.

In certain embodiments, the at least one elastic cord 11 includes a first elastic cord 11 and a second elastic cord 11 and the at least one hook 12 includes a first hook 12 and a second hook 12, with the first hook 12 coupled to the first elastic cord 11 and the second hook coupled to the second elastic cord 11. The elastic cord 11 may be stretchable and resilient to add tension when the punching device is coupled to a fencing 10.

The target pad 10 of the present invention may include any appropriate punching bag with an outer covering made of vinyl, leather, and the like. The filling material may include, but is not limited to, foam, sand, water, air, or any filling material that may withstand repeated punching without harming the user. For example, the filling material may be a dense foam so that it is not too soft or too hard when kicking, punching etc. The back portion may be made of a strong plastic, wood, or metal to support the target pad 10.

In certain embodiments, the target pad 10 includes a half cylinder shape having a semi-circular cross section. In such embodiments, the punching surface includes a curved portion of the half cylinder shape and the back portion includes a flat portion of the half cylinder shape. The back surface includes an upper portion and a lower portion. The clip 13 is coupled to the upper portion and the first elastic cord 11 and the second elastic cord 11 are coupled to the lower portion. The first elastic cord 11 and the second elastic cord 11 are spaced apart so that the clip 13 is disposed therebetween.

A method of releasably attaching a punching device to a fencing 14 may include the following. Provide the punching device described above. Place the back surface of the punching device against the fencing 14. Attach the clip 13 to the fencing 14. Loop the elastic cords 11 through the fencing 14, stretch the elastic cords 11 downwards away from the target pad 10, and attach the hooks 12 to the fencing 10. Doing the above steps attaches the punching device to the fencing 14, allowing a user to train by punching and kicking the target pad 10.

It should be understood, of course, that the foregoing relates to exemplary embodiments of the invention and that modifications may be made without departing from the spirit and scope of the invention as set forth in the following claims.

What is claimed is:

1. A punching device comprising:
a target pad comprising an outer covering defining an internal compartment, and a filler material disposed within the internal compartment, wherein the target pad comprises a punching surface and a back surface opposite the punching surface;
a clip coupled to the back surface of the target pad;
at least one elastic cord comprising a first end coupled to the back surface; and
at least one hook coupled to a second end of the at least one elastic cord.

2. The punching device of claim 1, wherein the at least one elastic cord comprises a first elastic cord and a second elastic cord and the at least one hook comprises a first hook and a second hook, wherein the first hook is coupled to the first elastic cord and the second hook is coupled to the second elastic cord.

3. The punching device of claim 2, wherein the back surface is substantially flat.

4. The punching device of claim 3, wherein the back surface comprises an upper portion and a lower portion, wherein the clip is coupled to the upper portion and the first elastic cord and the second elastic cord are coupled to the lower portion.

5. The punching device of claim 4, wherein the first elastic cord and the second elastic cord are spaced apart so that the clip is disposed therebetween.

6. The punching device of claim 1, wherein the target pad comprises a half cylinder shape having a semi-circular cross section, wherein the punching surface comprises a curved portion of the half cylinder shape and the back portion comprises a flat portion of the half cylinder shape.

7. The punching device of claim 1, wherein the filler material is a foam material.

8. A method of releasably attaching a punching device to a fencing comprising:
providing the punching device comprising:
a target pad comprising an outer covering defining an internal compartment, and a filler material disposed within the internal compartment, wherein the target pad comprises a punching surface and a back surface opposite the punching surface;
a clip coupled to the back surface of the target pad;
at least one elastic cord comprising a first end coupled to the back surface; and
at least one hook coupled to a second end of the at least one elastic cord;
placing the back surface of the punching device against the fencing;
attaching the clip to the fencing;
stretching the at least one elastic cord downwards away from the target pad; and
attaching the at least one hook to the fencing.

9. The method of claim 8, wherein the at least one elastic cord comprises a first elastic cord and a second elastic cord and the at least one hook comprises a first hook and a second hook, wherein the first hook is coupled to the first elastic cord and the second hook is coupled to the second elastic cord.

10. The method of claim 9, wherein the step of stretching and attaching comprises stretching the first elastic cord and the second elastic cord downwards away from the target pad and attaching the first hook and the second hook to the fencing.
